(19) United States
(12) Patent Application Publication
(10) Pub. No.: US 2012/0323447 A1
(43) Pub. Date: Dec. 20, 2012

(54) BUMPER ARRANGEMENT FOR AN AUTOMOBILE AND METHOD FOR OPERATING A BUMPER ARRANGEMENT IN A CRASH

(75) Inventors: MAX NIESSE, Borchen (DE); Torsten Gröning, Paderborn (DE)

(73) Assignee: Benteler Automobiltechnik GmbH, Paderborn (DE)

(21) Appl. No.: 13/326,982

(22) Filed: Dec. 15, 2011

(30) Foreign Application Priority Data
Dec. 15, 2010 (DE) 10 2010 054 639.9

(51) Int. Cl. B60R 19/34; B60R 21/0134; E05C 19/10

(52) U.S. Cl. 701/45; 293/133

(57) ABSTRACT

A bumper arrangement for an automobile includes a crossbeam with crash boxes and a pedestrian protection element arranged on the crossbeam. The material of the pedestrian protection element has a lower firmness compared to the material of the crossbeam. A deformation element is arranged in the pedestrian protection element. The deformation element can be retracted into the crossbeam in an impact with a pedestrian, so that only the pedestrian protection element produces a damping effect. In a high-intensity crash, the deformation element can be rigidly connected with the crossbeam and thus lengthen the available deformation path of the crash box along the deformation element.

### CROSS-REFERENCES TO RELATED APPLICATIONS

This application claims the priority of German Patent Application, Serial No, 10 2010 054 639.9, filed Dec. 15, 2010, pursuant to 35 U.S.C. 119(a)-(d), the content of which is incorporated herein by reference in its entirety as if fully set forth herein.

### BACKGROUND OF THE INVENTION

The present invention relates to a bumper arrangement for an automobile and to a method for operating a bumper arrangement in a crash.

The following discussion of related art is provided to assist the reader in understanding the advantages of the invention, and is not to be construed as an admission that this related art is prior art to this invention.

Bumper arrangements are used in automobiles both on the front side and the rear side to convert the impact energy into deformation energy in an impact and/or to deflect objects stricken by the automobile. Conventional bumper arrangements consist of a rigid crossbeam which has crash boxes located on the left side and on the right side on the automobile, wherein the bumper arrangement with the crash boxes is attached to side rails of the body.

The crash boxes operate here as deformation elements and convert in an impact the generated kinetic energy into deformation energy. In low-intensity impacts, for example in a vehicle crash at speeds below 15 km/h, the bumper arrangements are constructed to prevent as much as possible a deformation of the remaining automobile body. This lowers the repair costs. In high-intensity impacts, for example in a vehicle crash at more than 50 km/h, the bumper arrangements reduce in cooperation with a front or rear section, in particular the side rails, the intensity of the crash. The accelerations operating on the vehicle occupants are thereby kept as small as possible, so that they always remain at a subcritical level.

In particular the crossbeams, but also the crash boxes, are produced from hard materials. These are mostly made of metallic materials, but can also be manufactured from fiber composite materials. The bumper arrangements are rigid when an automobile hits a pedestrian. The impact energy of an automobile weighing typically more than 1000 kg overwhelms the soft extremities of a pedestrian in a collision with a pedestrian. Due to regulatory requirements and the self-commitment of the automobile manufacturers to provide pedestrian protection, the bumper arrangements must additionally keep the stress on the lower extremities of a pedestrian small. To this end, impact tests with a leg impactor are performed, whereby several limit values must be satisfied.

It is known in the art to attach soft materials in front of a crossbeam for absorbing energy in an impact with a pedestrian. For example, foam materials or plastics are used which have a damping effect in an impact. These pedestrian protection systems are referred to as passive pedestrian protection systems.

Also known are active pedestrian protection systems which sense a possible crash with a pedestrian already before the impact and implement corresponding measures. According to the state-of-the-art, for example an engine hood can be angled which then would provide a deformation path for a pedestrian hitting the hood. According to another known active pedestrian protection measure, a front skirt is advanced by way of spring actuating means. This produces an additional deformation space which can be used to dampen the intensity of the impact of the pedestrian.

It would therefore be desirable and advantageous to obviate prior art shortcomings and provide an improved bumper arrangement with integrated pedestrian protection, which satisfies the requirements for pedestrian protection and which simultaneously uses the deformation space occupied by the pedestrian protection as the deformation path for kinetic energy dissipation in a high-intensity crash.

### SUMMARY OF THE INVENTION

According to one aspect of the present invention, a. bumper arrangement for an automobile includes a crossbeam, a crash box arranged on the crossbeam, a pedestrian protection element arranged on the crossbeam, wherein a material of the pedestrian protection element has a lower firmness compared to a material of the crossbeam, and a deformation element arranged in the pedestrian protection element.

According to an advantageous feature of the present invention, the pedestrian protection element may essentially be produced from a foam material or from Styrofoam or from a plastic material. The pedestrian protection element may be arranged on a crossbeam disposed at the front of the vehicle before the crossbeam in the travel direction and on a crossbeam disposed at the rear of the vehicle after the crossbeam in the travel direction. Advantageously, the pedestrian protection element may be formed along the entire length of the crossbeam. The pedestrian protection element thereby operates to dampen the impact intensity in an impact with a pedestrian. According to an advantageous feature of the present invention, the additional deformation element may be integrated or arranged in the pedestrian protection element. The deformation element increases the crash stiffness of the pedestrian protection element.

According to another advantageous feature of the present invention, the deformation element itself may be formed as a crash box. Within the context of the invention, this refers to a deformation profile which satisfies the functional aspects of a crash box. In an impact, kinetic impact energy is converted into deformation energy by forming creases in the deformation element itself. The deformation element thus forms creases in the pedestrian protection element itself and thereby absorbs crash energy. Within the context of the invention, the deformation element may be constructed as a creasing crash box, a retraction crash box, an upending crash box or also as peel crash box.

According to an advantageous feature of the present invention, the deformation element preferably may have initial profiles, for example transverse beads and/or longitudinal beads. With these initial profiles it is possible to stiffen the deformation element itself and to pre-adjust the crash properties. For example, the transverse beads may be used to cause specific crease formation in a deformation of the deformation element itself. When longitudinal beads are used, the deformation element is stiffened so as to require an increased release force before the deformation element itself develops creases. This increases the dissipated deformation work and hence the ability to absorb crash energy.

According to another advantageous feature of the present invention, the material of the deformation element may have a firmness which is greater than the firmness of the pedestrian protection element. In particular, the firmness may be significantly greater. According to an advantageous feature of the present invention, the deformation element may be made from a metallic material. For example, a light-metal material, in particular an aluminum or magnesium material, may be used. Within the context of the invention, however, steel may also be used as material. The deformation element may also be produced from a fiber composite material. Advantageously, the firmness of the material itself may be selected to be high enough so as to be able to convert the kinetic energy released in a vehicle crash into deformation energy. Due to the ductility of the deformation element, creasing caused by the shape change does not generate cracks in the material itself.

According to an advantageous feature of the present invention, the crossbeam may have an opening, wherein at least a section of the deformation element may be arranged in the opening of the crossbeam. The opening of the crossbeam may hereby be arranged at the front of the front crossbeam in the travel direction of the vehicle and at the rear of the rear crossbeam in the travel direction of the vehicle. At least sections of the deformation element may hereby engage with the opening or may be arranged in the opening in the travel direction. In particular, the deformation element may have a foot region which is arranged inside the opening.

According to another advantageous feature of the present invention, the deformation element may be inserted in the crossbeam. In a crash, in particular in an impact with a pedestrian, the deformation element is pushed into a hollow space of the crossbeam. This releases the damping effect of the pedestrian protection element, without the deformation element having an adverse effect in an impact with the pedestrian due to its higher stiffness compared to the pedestrian protection element.

According to an advantageous feature of the present invention, for realizing an additional deformation path, a locking means for limiting the displacement of the deformation element may be arranged in the region of the opening. The locking means ensures, optionally after a desired actuation, that the deformation element is rigidly disposed inside the opening of the crossbeam. The deformation element hence operates like a crash box, so that the deformation path available during the deformation is lengthened in a high-intensity crash, in particular in a crash at speeds higher than 15 km/h. By combining the deformation element and the pedestrian protection element according to the invention, the crash safety of an automobile and the pedestrian protection safety can be simultaneously increased while keeping the installation dimensions small. The combination according to the invention can be produced particularly cost-effectively, is failsafe and has a long service life. It therefore satisfies all functions and can therefore be used with a large selection of automobiles, in particular in mass-produced automobiles.

According to an advantageous feature of the present invention, the locking means may additionally include an active actuator. The active actuator may, for example, be a mechanical locking means, an electrical actuator, a pyrotechnic actuator or a similar actuator. The locking means can be actively influenced or adjusted and/or controlled with the active actuator.

According to an advantageous feature of the present invention, the locking means may be formed as a movable bezel. The movable bezel can be moved behind the deformation element in a high-intensity crash, so that the deformation element is rigidly connected with the crossbeam and is prevented from moving into the crossbeam. An active actuator may here be implemented as a longitudinal actuator or as a servomotor. The bezel may also be held under pretension by a spring, allowing it to rapidly move into its locking position when the spring is released.

According to another advantageous feature of the present invention, the locking means may be implemented as a hook. For example, the hook may be attached on the crossbeam, catching or locking the deformation element.

According to an advantageous feature of the present invention, the bumper arrangement may include a control sensor system for controlling the active actuator. The control sensor system may be designed as pre-crash sensor system which senses an impending impact already before the impact actually occurs or senses the impact directly and immediately during the impact. The control sensor system then transmits control signals to the active actuator which locks the deformation element.

According to another aspect of the invention, a method for operating a bumper arrangement having at least one of the aforedescribed features of the bumper arrangement in a crash includes the steps of sensing an impending crash, differentiating between a soft impact (pedestrian impact) or a hard impact (vehicle crash), in a soft crash, leaving the locking means in the open position, so that the deformation element is pushed into the crossbeam by the impact, and in a hard trash, moving the locking means into the closed position, so that the deformation element operates as a crash box.

A soft crash is hereby essentially defined as an impact with the pedestrian. In other words, the impact occurs at a speed of less than 30 km/h, in particular less than 20 km/h. The term pedestrian impact may also include an impact with an object softer than the automobile. This includes, for example, wildlife accidents, in particular accidents with small game, as well as the impact of a stroller or a walker.

The term hard impact within the context of the invention relates to a high-intensity vehicle crash. This assumes a speed above 10 km/h, in particular above 15 km/h, and particularly preferred above 30 km/h. This includes an impact with a substantially rigid object, for example, with other automobile or a barrier, with a lamppost, or with a wall or guardrail.

Advantageously, a pre-crash sensor system already installed in the vehicle or the sensor system installed in the vehicle may be relied on for sensing the impending impact, which facilitates a cost-effective implementation of the system in automobiles, in particular in high-volume production automobiles.

According to yet another aspect of the invention, a method for operating a bumper arrangement having at least one of the aforedescribed features of the bumper arrangement in a crash includes the steps of sensing an impending crash, differentiating between a soft impact (pedestrian impact) or a hard impact (vehicle crash), in a soft crash, when the locking means are initially in a closed position, moving the locking means into an open position, so that the deformation element is pushed into the crossbeam by an impact; and in a hard trash, leaving the locking means in a closed position, so that the deformation element operates as the crash box.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a bumper arrangement according to the invention in a first cross-sectional view;

FIG. 2 shows a bumper arrangement according to the invention after a pedestrian impact;

FIG. 3 shows a bumper arrangement according to the invention after a crash impact;

FIG. 4 shows a locking system according to the invention using a movable bezel; and

FIG. 5 shows a locking system according to the invention using a hook.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

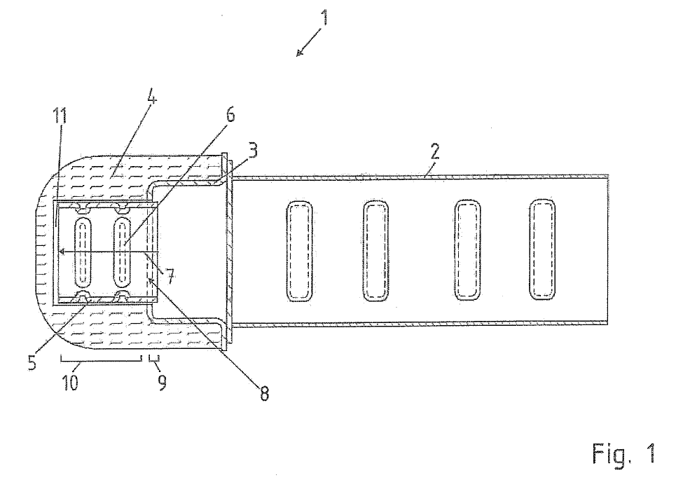

Turning now to the drawing, and in particular to FIG. 1, there is shown a bumper arrangement 1 according to the invention for installation on an unillustrated automobile. The bumper arrangement 1 includes a crash box 2, a crossbeam 3 and a pedestrian protection element 4. A deformation element 5 is arranged according to the invention in the pedestrian protection element 4 itself. The deformation element 5 has in turn transverse beads 6 generating specific creases in a crash. In the longitudinal direction 7 of the deformation element 5, a foot section 9 of the deformation element 5 is located at least with sections inside an opening 8 of the crossbeam 3. A deformation region 10 of the deformation element 5 extending from the foot region 9 in the longitudinal direction 7 is arranged in a first opening 11 of the pedestrian protection element 4. The bumper arrangement 1 according to the invention thus combines the highest crash safety for very different crash requirements, while simultaneously taking up little installation space.

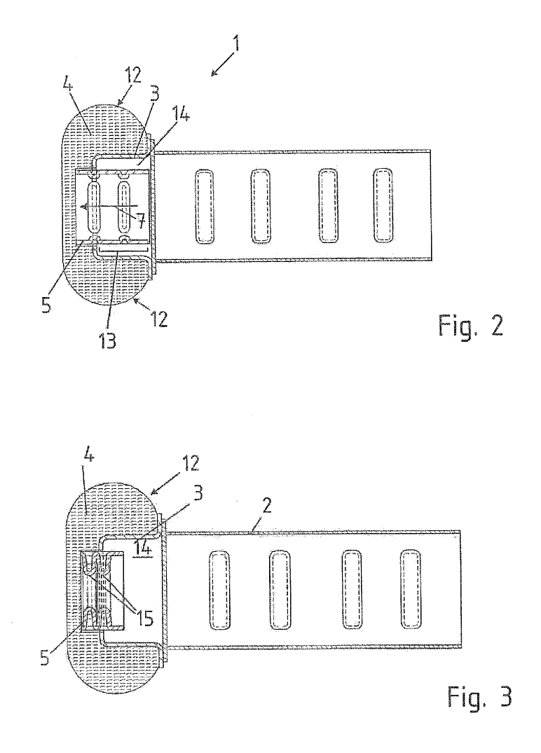

FIG. 2 shows the bumper arrangement 1 according to the invention after an impact with a pedestrian. The pedestrian protection element 4 itself had a damping effect on the unillustrated pedestrian due to the formation of bulges 12. The deformation element 5 is hereby retracted by a displacement path 13 into the interior space 14 of the crossbeam 3. The deformation element 5 has not undergone plastic deformation, so that the impacting pedestrian is dampened by the pedestrian protection element 4 to the greatest possible extent.

FIG. 3 shows an impact in a vehicle crash. The pedestrian protection element 4 has here also formed bulges 12. However, the pedestrian protection element 4 has only a insignificantly small damping effect compared to the deformation energy forming the creases 15 on the deformation element. The deformation element itself has converted kinetic energy into deformation energy of the deformation element 5, wherein the deformation element 5 is illustrated here in its deformed state with the corresponding creases 15. However, the impact was only a low-intensity vehicle crash, so that the actual crash box 2 itself is not deformed.

FIG. 4 shows a movable bezel 16 limiting the displacement path 13 of the deformation element 5. In a detected vehicle crash, the bezel 16 can move behind the deformation element 5, thereby limiting movement into the interior space 14 of the crossbeam 5 by the displacement path 13. The bezel 16 ensures that the deformation element 5 is rigidly connected with the crossbeam 3 and thus converts and/or absorbs the crash energy in form of deformation energy.

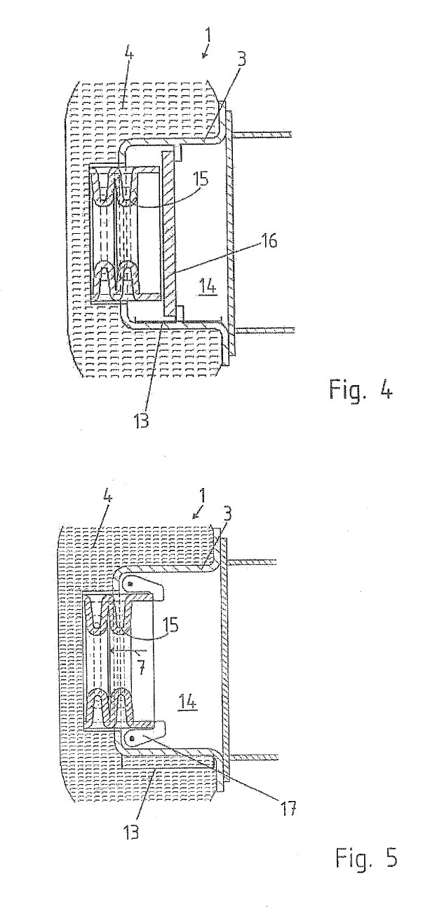

FIG. 5 shows another locking variant with a hook 17. The displacement path 13 of the deformation element 5 is here limited by adjustable hooks 17. In this embodiment, too, the hooks 17 ensure that complete movement by the maximally possible displacement path 13 into the interior space 14 of the crossbeam 3 is limited.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A bumper arrangement for an automobile, comprising:
a crossbeam,
a crash box arranged on the crossbeam,
a pedestrian protection element arranged on the crossbeam, wherein a material of the pedestrian protection element has a lower firmness compared to a material of the crossbeam, and
a deformation element arranged in the pedestrian protection element.

2. The bumper arrangement of claim 1, wherein the deformation element is constructed as the crash box.

3. The bumper arrangement of claim 1, wherein the deformation element comprises initial profiles.

4. The bumper arrangement of claim 3, wherein the initial profiles comprise at least one of transverse beads and longitudinal beads.

5. The bumper arrangement of claim 1, wherein a material of the deformation element has a firmness which is greater than the firmness of the pedestrian protection element.

6. The bumper arrangement of claim 1, wherein the crossbeam comprises an opening, wherein at least a section of the deformation element is arranged in the opening.

7. The bumper arrangement of claim 6, wherein the section of the deformation element is a foot region of the deformation element.

8. The bumper arrangement of claim 7, wherein the deformation element is configured for insertion into the opening.

9. The bumper arrangement of claim 6, further comprising a locking means arranged in a region of the opening for limiting a displacement path of the deformation element.

10. The bumper arrangement of claim 9, wherein the locking means comprises an active actuator.

11. The bumper arrangement of claim 9, wherein the locking means is constructed as a movable bezel.

12. The bumper arrangement of claim 9, wherein the locking means is constructed as a hook.

13. The bumper arrangement of claim 10, further comprising a control sensor system for controlling the active actuator.

14. A method for operating a bumper arrangement in a crash, said bumper arrangement comprising a crossbeam having an opening, a crash box arranged on the crossbeam, a pedestrian protection element arranged on the crossbeam, wherein a material of the pedestrian protection element has a lower firmness compared to a material of the crossbeam, a deformation element arranged in the pedestrian protection element, and locking means arranged in a region of the opening for limiting a displacement path of the deformation element, the method comprising the steps of:
sensing an impending crash;
differentiating between a soft impact caused by a pedestrian and a hard impact caused by a vehicle;
in a soft crash, leaving the locking means in an open position, so that the deformation element is pushed into the crossbeam by an impact; and
in a hard trash, moving the locking means into a closed position, so that the deformation element operates as the crash box.

15. A method for operating a bumper arrangement in a crash, said bumper arrangement comprising a crossbeam having an opening, a crash box arranged on the crossbeam, a pedestrian protection element arranged on the crossbeam, wherein a material of the pedestrian protection element has a lower firmness compared to a material of the crossbeam, a deformation element arranged in the pedestrian protection element, and locking means arranged in a region of the opening for limiting a displacement path of the deformation element, the method comprising the steps of:
sensing an impending crash;
differentiating between a soft impact caused by a pedestrian and a hard impact caused by a vehicle;
in a soft crash, moving the locking means into an open position, so that the deformation element is pushed into the crossbeam by an impact; and
in a hard trash, leaving the locking means in a closed position, so that the deformation element operates as the crash box.
